(19) United States
(12) Patent Application Publication
(10) Pub. No.: US 2026/0148126 A1
(43) Pub. Date: May 28, 2026

(54) HYBRID EXPANDING LANGUAGE MODEL SYSTEM

(71) Applicant: Microsoft Technology Licensing, LLC, Redmond, WA (US)

(72) Inventor: Raphael Antunes FORTUNA, Redmond, WA (US)

(21) Appl. No.: 18/959,878

(22) Filed: Nov. 26, 2024

(51) Int. Cl. G06N 20/00

(52) U.S. Cl. CPC G06N 20/00

(57) ABSTRACT

A disclosed system includes a node network with a plurality of nodes that each includes a generative machine learning model and a node-specific base context storing at least one instruction that the generative machine learning model of the node is to follow when processing inputs. The system further includes a context-updater that autonomously updates the node-specific base context for select nodes of the plurality of nodes by leveraging one or more generative machine learning models to analyze user inputs received by the system and metadata generated by the system.

### BACKGROUND

Using a variety of training techniques and task-specific training datasets, it is possible to train a generative machine learning model to perform a wide variety of tasks including text generation and completion, summarization, translation, sentiment analysis, classification and categorization, language correction and enhancement, text-to-code conversation and programming assistance, information extraction and retrieval, data analysis reporting, and more.

Some user requests can be logically reduced into sub-tasks that are well-suited for processing by models with different characteristics, such as models trained to produce different types of outputs. For example, a user might ask a chatbot to generate a line of executable code that provides some desired functionality. Generating this executable code may entail an information retrieval task that queries a relevant set of reference documents, a summarization task to condense the information retrieved into a concise natural language description of coding instructions, and a text-to-code conversation task that translates the natural language coding instructions into executable code. These three types of tasks could, in theory, be sequentially delegated to a first generative machine learning model trained to conduct semantic analysis for information retrieval, a second-generative machine learning model trained to summarize large bodies of text and a third-generative machine learning model that translates natural language text into executable code.

Within this framework emerges a need for a multi-model artificial intelligence (AI) system with inter-model communication capability. Presently, some model architectures exist that utilize model-independent agents to facilitate communication between different generative machine learning models, such as by constructing API calls that allow data to flow from one generative machine learning model to another. However, the agents in these existing systems are typically individually programmed and require very specific input instructions. Updates within this type of system entail significant, developer-performed fine-tuning of each individual agent in the system. These systems operate statically and require significant developer efforts to update and maintain.

### SUMMARY

According to one implementation, a system includes a node network and a context updater. The node network includes a plurality of nodes that each stores a generative machine learning model and a node-specific base context. The node-specific base context of each node stores at least one instruction that the generative machine learning model of the node is to follow when processing inputs received at the node. The context-updater autonomously updates the node-specific base context for select nodes of the plurality of nodes by performing operations that include: analyzing a series of sequential user inputs received by the node network, identify a select user input indicative of user sentiment; based on the select user input indicative of user sentiment, identifying an unfulfilled request from the sequential user inputs; analyzing metadata generated by a chain of nodes to identify an exception raised by a select node during the processing of the unfulfilled request; instructing a generative machine learning model to utilize the metadata to generate a root cause descriptor identifying a root cause of the exception, the root cause descriptor identifying information not accessible to the chain of nodes during the processing of the unfulfilled request; selecting, from the chain of nodes, a responsible node for supplying the information at a future time; and based on the root cause descriptor for the exception and the node-specific base context of the responsible node, autonomously updating the node-specific base context of the responsible node.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example hybrid expanding language model (HELM) system implementing the disclosed technology.

FIG. 2 illustrates an example node network within a HELM system implementing aspects of the herein-disclosed technology.

FIG. 3 illustrates a context updater that performs operations to autonomously update the node-specific base context of select nodes of an example HELM system.

FIG. 4 illustrates an example node network within a HELM system with nodes that execute logic for autonomously splitting themselves into two or more nodes when the node-specific base context in the node is determined to satisfy splitting criteria.

FIG. 5 illustrates example for autonomously updating the node-specific base context of a select node within a HELM system implementing the herein-disclosed technology.

FIG. 6 illustrates an example schematic of a processing device suitable for implementing aspects of the disclosed technology.

### DETAILED DESCRIPTION

The technology disclosed herein relates to a multi-model processing system referred to herein as a hybrid expanding language model (HELM) system. The HELM system includes a network of nodes that store language models and that communicate directly with one another to facilitate multi-model processing on user inputs. The HELM system can autonomously update information stored within the nodes to improve their respective functionalities over time and execute logic to instantiate new nodes when certain criteria are satisfied, allowing the system to grow and autonomously tune different nodes for different areas of specializations. As used herein, an “autonomous update” refers to an update that occurs without human input.

Each node in the HELM network includes at least a language model and a node-specific base context storing at least one instruction that the language model within the node is instructed to follow each time it processes a new user input. Within the HELM system, user inputs flow through chains of nodes that perform different processing subtasks related to each user request received by the HELM system.

In addition to the above-described network of nodes, the herein-disclosed HELM system further includes an AI-driven application referred to herein as a “context-updater” that learns from user inputs and autonomously updates the node-specific base contexts of select nodes within the HELM network to improve system performance over time. The context-updater incrementally modifies, expands, and improves the instructions that are stored within each node and passed to the language model of the node each time a new user input is processed. These updates to the node-specific base context of a node gradually improve the node's capability to process inputs correctly and in a manner that is consistent with the expectations of an end user that the system is configured to serve. This autonomous update capability allows the HELM system to expand its capabilities over time, eliminating the need to employ a developer to troubleshoot shortcomings and/or manually update or re-program node-specific logic.

Still, in addition to the above, some implementations of the HELM system include nodes that execute logic for autonomously splitting themselves into two or more nodes when the node-specific base context in the node grows to a certain size or is otherwise determined to satisfy splitting criteria. For example, a node may elect to split itself into two different nodes that each store a different duplicative instance of the same language model and a different portion of the node-specific base context stored by a single node prior to the split. This autonomous splitting capability can improve individual node performance by reducing the size of the instructions sent to the node's language model along with each user input, which in turn reduces model hallucinations and the likelihood that the language model may miss critical components of the instructions when processing a given user input. This autonomous splitting functionality also allows the individual nodes of the HELM system to become more specialized over time while simultaneously improving the system's ability to generate outputs consistent with the expectations of the end-user interacting with the system. This system improves upon existing AI because, unlike agent-based node systems that require manual interventions to facilitate both maintenance and improvements, the HELM system is able to troubleshoot its own shortcomings and modify its instructions to work expand and evolve its capabilities over time.

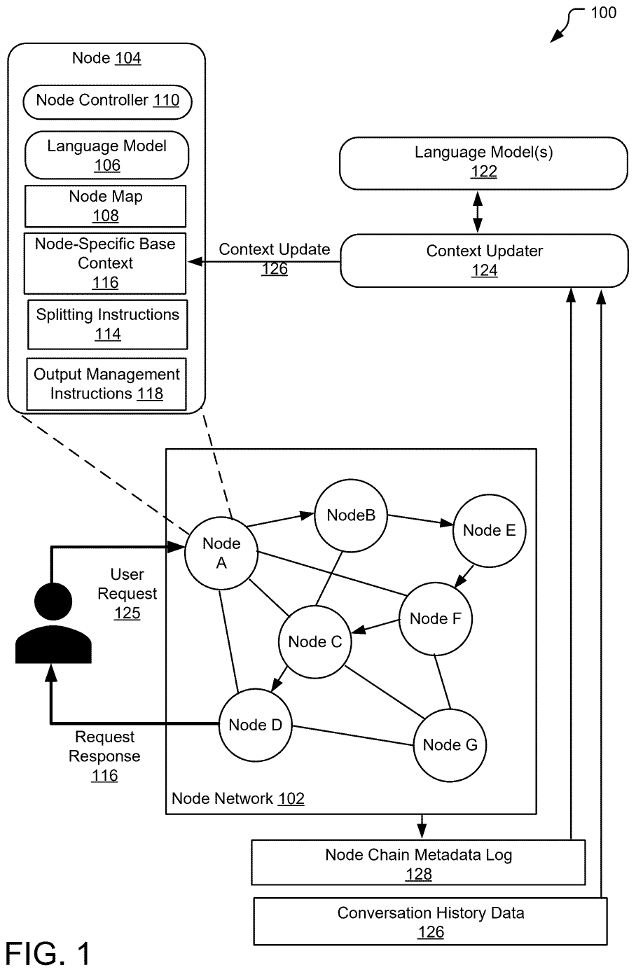

FIG. 1 illustrates an example HELM system 100 implementing the disclosed technology. The HELM system 100 includes a node network 102, including nodes (e.g., Node A-Node G) that share at least some direct connectivity. Each node in the node network includes an instance of a language model or an address of an instance of a language model. In various implementations, the different model instances stored in the different nodes of the node network 102 may include some instances of the same language model (e.g., two or more instances being the same model and model version trained on the same or different training datasets) and/or some instances of different language models, such as instances of different types of models or model versions.

As used herein, the term “language model” refers to a generative machine learning model that is trained to interpret textual inputs. This term is intended to encompass natural language processing (NLP) models as well as models that process other types of textual inputs, including text-based code and textual characters, such as certain multimodal models that can receive prompts that include text, image, audio, and/or video data and that may generate outputs of multiple types that are not necessarily the same as the input type. Example types of language models include transformer-based models such as generative pre-trained transformer (GPT) models, Open Pretrained Transformer (OPT) models, and Bidirectional Encoder Representations from Transformers (BERT) models, as well as Bioscience Large Open-science Open-access Multilingual (BLOOM) models, seq2seq models, long short-term memory (LSTM) network, and recurrent neural networks (RNNs). Examples of publicly available multimodal language models include the Mistral AI model and the large language model Meta AI (LLaMa) model.

In various implementations, the different nodes in the node network 102 are stored within and executed by the same or different hardware components. In some cases, the nodes are executable in parallel. Each node includes data and executable logic stored in memory as well as a processing system. In some implementations, a processing system may be shared between two or more nodes. In other implementations, each node includes its own processing system. Likewise, the data stored by two or more nodes may, in some implementations, reside within a same memory device, with each node being allocated a discrete region of the memory. For example, some or all nodes in the node network 102 are locally stored on and executed by a user processing device (e.g., a personal computer). In other implementations, some or all nodes reside on hardware that is not shared with any other node in the node network 102. For example, different nodes are distributed across different processing devices - e.g., between user device(s), local network devices, and web-based servers. As a result, some nodes may have different access to data. In still other implementations, a majority or all nodes of the node network are web-based and communicate with a central (e.g., “front end”) node that executes on a user device. Having a plurality of nodes gives efficiency where parallelization is possible. Having a plurality of nodes gives robustness since if a node fails other nodes are able to operate. Having a plurality of nodes facilitates scalability. Having a plurality of nodes facilitates load balancing.

The node network 102 is initially developed and deployed to perform autonomous tasks relating to a particular technology domain. Each different node is equipped to automate a subset of tasks pertaining to a sub-domain of the technology domain. By example, the node network 102 may be designed to serve as a general-purpose computer assistant that automates computer tasks for a user or enterprise. In this case, the different nodes in the node network 102 have AI expertise in different sub-domains of the technology domain (“computer automation”) and are tasked with executing tasks related to those specific sub-domains. For example, one node may include a language model trained to understand directory structures and how to access different types of information; another node may include a language model trained to translate natural language requests to driver commands understood by the operating system kernel; and another node may include a language model trained to generate API calls to third-party endpoints that provide services to the user and/or store user data remotely. By designing individual nodes that include different language models trained with different types of training data and/or to perform different types of tasks, the node network 102 can, as a whole, be leveraged to deliver powerful computer automation that is driven, at least in part, by natural language inputs formulated by an end user.

In another implementation, the node network 102 is implemented within a robotic home assistant, such as an in-home robot that ambulates around the house to perform user-requested tasks (e.g., washing windows, vacuuming, making beds). In this implementation, the different nodes can be viewed as buckets that provide the skeletal functionality and support for different types of tasks that may be useful in the technology domain of in-home robotic assistance. By example, suppose an end user asks their in-home robotic assistant to “go get a glass of water.” Fulfilling this request entails executing sub-tasks that include figuring out where the robot is currently located in the house, figuring out where the kitchen is, generating a map, ambulating the robot to follow a route along the map, opening a drawer to retrieve a glass, filling the glass, etc. These different sub-tasks can be delegated to different system nodes with different AI expertise. For example, a robotic in-home assistant implementing the HELM system 100 may include a first node that stores a language model capable of generating API calls that can be used to retrieve location information (e.g., robot's current location), a second node with a language model trained to locate items within a user's home (e.g., trained to understand the layout of the home, locations of cabinets, closets, and where various objects); a third node trained to generate a map between two locations when provided with those locations; a fourth node trained to receive route and map data and to generate calls to movement functions that ambulate the robot along the route, and so on.

Although each of the nodes in the node network 102 may be equipped with different AI and data, the general architecture of each node is, in one implementation, the same. An example of this architecture is shown with respect to node 104. In FIG. 1, the node 104 is shown to correspond to Node A; however, the architecture shown and described with respect to node 104 could be implemented within any or all nodes of the node network 102.

As shown, the node 104 stores a language model 106 that is trained to perform a certain task or class of processing tasks on text-based inputs. Examples of classes of tasks include natural language generation, text-to-code conversion, database or API call construction, remote endpoint access, map generation, classification and categorization, information retrieval, summarization, and countless others.

In addition to the language model 106, the node 104 is also shown as storing a node-specific base context 116, a node map 108, output management instructions 118, and splitting instructions 114, each of which is discussed in turn below. In some implementations, system nodes include fewer than all of the components shown with respect to the node 104. The node-specific base context 116 includes a set of natural language instructions (one or more instructions) that is passed to the language model 106 with each input that the language model 106 is tasked with processing. The language model 106 is instructed to process the input received at the node 104 according to the node-specific base context 116 that is stored by the node 104. The node-specific base context includes at least one instruction that tells the language model 106 what to do with the other inputs it is receiving (e.g., user request data) and/or information to consider when processing the other inputs. In some implementations, these instructions are tailored to a particular type of task that the model's training dataset is designed or well-suited to support.

At the time that each node is initialized within the HELM system 200, the node-specific base context 116 of each node may typically consist of one or a few short sentences. If, for example, the language model 106 is trained to perform summarization tasks, the node-specific base context 116 may read “summarize the user inputs,” “summarize each sentence into one keyword,” or “summarize the text you receive to pull the most important information that is needed to run commands in a command line.” Likewise, if the language model 106 is a multi-modal model designed to interpret or generate images, the context may read “summarize this image” or “summarize the people that appear in this image.” For some system nodes, this initial node-specific context is autonomously modified for variation and/or to grow in length over time, expanding the node's capabilities as described below with respect to a context updater 124.

In one implementation, each user request (e.g., a user request 125) is received by a front-end node in the node network 102 (e.g., Node A in the illustration shown) that is tasked with breaking down the user request 125 into sub-tasks that are, in turn, executed by different respective nodes within the node network 102. For example, the node network 102 includes a front-end node (e.g., Node A) with a node-specific base context 116 that instructs the language model 106 to “identify a complete set of sub-tasks that are needed to complete a task that the user is requesting.” In this case, the front-end node generates and outputs a list of sub-tasks that need to be performed to the user request 125, appends those outputs to the inputs that it received, and passes the combined data to another node in the network, which in turn completes one or more of the sub-tasks before appending its own output to the data and passing it on to another node in the system. This data that is passed from node to node during the processing of the user request 125 is referred to herein as the “request data.”

In some implementations, the nodes of the node network are configured to direct the request data along a static route through the node network 102 that is, for example, fixed for all requests or dynamically selected based on the specific category of task being requested in any given instance. For instance, requests relating to code debugging may traverse a first static, predefined path in the node network 102, while requests relating to new code generation traverse a second static, predefined path.

In other implementations, however, the nodes in the node network 102 perform operations for autonomously and dynamically selecting the processing route that the request data follows through the node network 102. In this implementation, each node in the HELM system 100 stores a node map 108 and output management instructions 118, as shown in FIG. 1. The node map 108 identifies other nodes in the node network 102 with direct connectivity to the node storing the map and further identifies the node-specific base context 116 that is stored by each of the nodes identified within the node map 108. For example, assuming the node-to-node connections are as shown with respect to the node network 102, the node map 108 stored in node A may identify connections to Node B, Node, F, Node C, and Node D (as shown in the figure) and also stores the node-specific base context 116 of each of these nodes. The output management instructions 118 within the node 104 instruct the language model 106 to use the node-specific base contexts described in the node map 108 to select a next node in the node network 102 to receive and process the request data.

The node controller 110 includes logic executable to prepare and transmit inputs (e.g., prompts) for the language model 106. Upon receiving request data as input to the node 104, the node controller 110 passes the request data to the language model 106 along with the node-specific base context 116, which generally tells the language model what to do with the request data. In implementations that support dynamic route selection, these inputs passed to the language model 106 may further include the node map 108 and the output management instructions 118, which further instruct the language model 106 to output a “next node” to receive the request data in addition to the outputs that it generates while processing the request data.

In addition to the node network 102, the HELM system 100 includes a context updater 124 that selectively and autonomously updates the node-specific base context 116 within each node, as is further described below. Due to the context updater 124, the node-specific base context 116 in each node may evolve and/or grow in length over time with repeated use by an end user.

Notably, the term “context” is sometimes used in the AI industry to refer to conversation history data that is passed to an AI model as an input. For example, a user asks a chatbot a question, and the chatbot passes the question along with the entire corresponding conversation history (the “context”) to a language model. As the conversation history evolves, the size of the context also grows. This use of the term “context” is markedly different than the intended definition of the term “node-specific base context” used herein. The node-specific base context 116 does not include user inputs or conversation history data and instead includes a set of instructions stored by the node 104 that generally include an instruction for processing request data (e.g., the user inputs and data output by other nodes). Any and all updates to the base context 116 are AI-generated and not verbatim representative of user inputs. The request data, in contrast, may, in some implementations, include conversation history data 126 in addition to the user request 125.

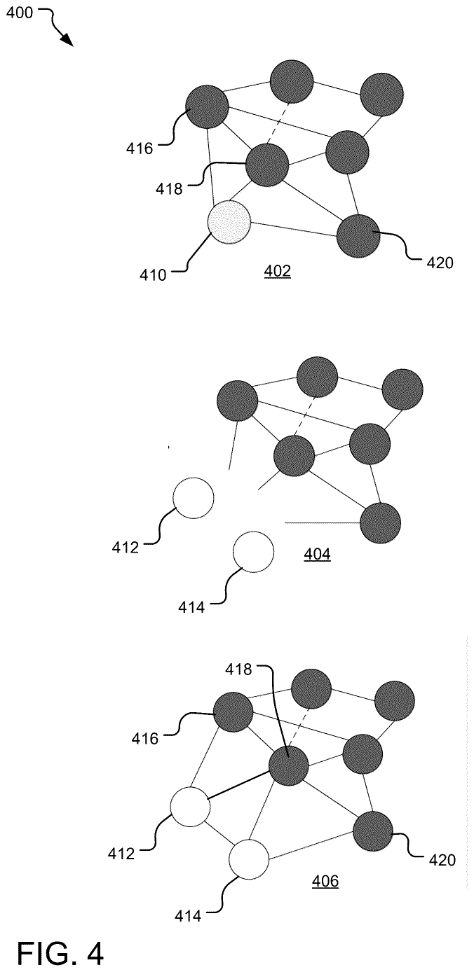

As the node-specific base context 116 grows in length because of these autonomous updates implemented by the context updater 124, the node controller 110 periodically evaluates the node-specific base context 116 in view of splitting instructions 114. The splitting instructions 114 define split criteria that, when satisfied by the node-specific base context 116, trigger a “split” of the node 104 into two nodes. Examples of split criteria are further described with respect to FIG. 4. When the node controller 110 determines that the node-specific base context 116 satisfies the split criteria set forth in the splitting instructions 114, the node controller 110 enforces the splitting instructions 114, which provide for splitting (e.g., partitioning) the node-specific base context 116 into two or more portions, overwriting the locally-stored node-specific base context with one of the portions (e.g., a subset of the original node-specific base context), and instantiating one or more new nodes with respective node-specific base contexts set to equal other respective portions of the split context.

The context updater 124 is a critical, logical component that allows the nodes of the HELM system 100 to evolve over time, becoming more specialized in their respective task domains and more consistent in generating outputs that align with the expectations of the end user that the HELM system 100 is configured to serve. The context updater 124 autonomously updates the node-specific base context 116 of select nodes in the network based on processing of two types of input data - namely, conversation history data 126 and data stored within a node chain metadata log 128.

The conversation history data 126 includes user inputs sequentially provided to the node network 102 over a continuous period of time, such as throughout a login session that may be viewed as a “conversation.” The conversation history data 126 may, in some implementations, include outputs that are returned to the user in response to the processing of each user request. In contrast to this, the node chain metadata log 128 includes metadata generated by the nodes within the node network 102 during the processing of the user request 125. If, for example, the user request 125 is received at node A and request data (e.g., the user request 125 plus outputs appended by each node in the chain) is passed sequentially to Node B, E, F, C, and D, each node in this chain generates and appends metadata to the node-chain metadata log 128. This metadata identifies a master chain of actions performed in association with the processing of the user request 125 as well as the node that performed each action (e.g., functions called by the node, external calls placed) and the input(s) and output(s) to each action.

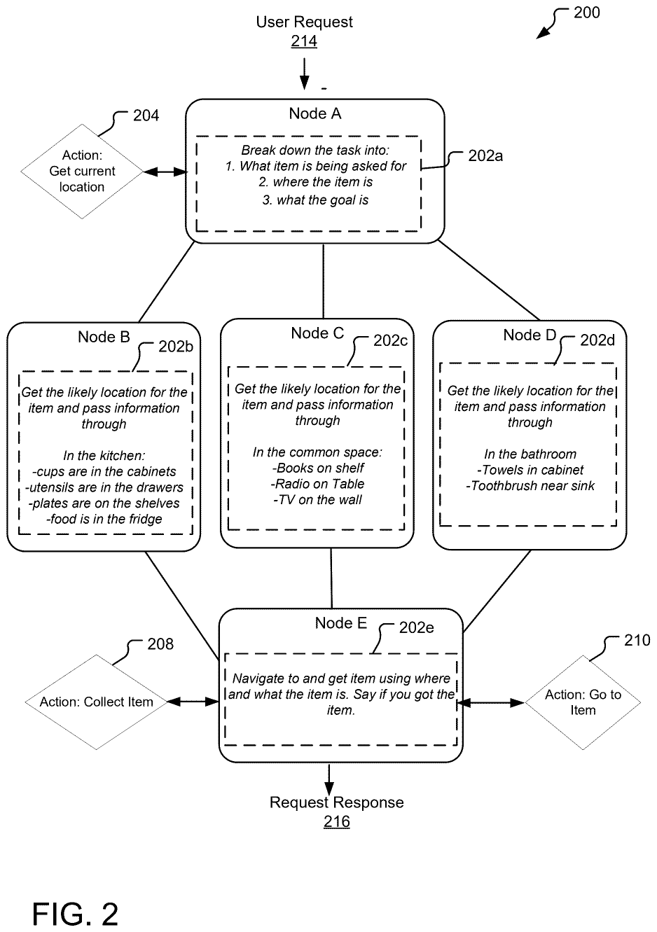

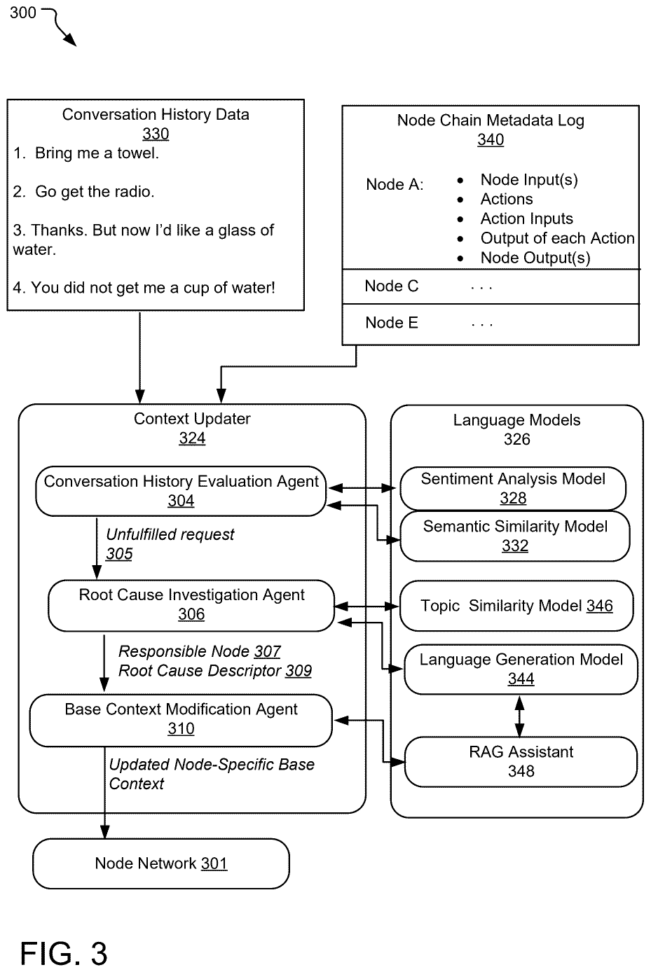

The context updater 124 interacts with various language model(s) 122 to derive certain information from the node chain metadata log 128 and the conversation history data 126 that collectively facilitates the identification of specific performance shortcomings of the HELM system and the root cause of each shortcoming. Using this information, the context updater 124 autonomously modifies the node-specific base context 116 of select nodes in the node network 102 to reduce the likelihood of the performance shortcoming being observed again in the future. More detailed examples of the logic employed are discussed with respect to FIG. 2 and FIG. 3.

FIG. 2 illustrates an example node network within a HELM system 200 implementing aspects of the herein-disclosed technology. In this example, the node network includes five nodes labeled A, B, C, D, and E, respectively. Although not shown, it is assumed that each of the nodes stores an instance of a language model. In some implementations, two or more of the system nodes may share a single language model instance. Each of the nodes stores a node-specific base context (e.g., 202a, 202b, 202c, 202d, and 202e) that includes at least one instruction that the language model of the node is to follow when processing request data received at the node.

In the example shown, it is assumed that Node A stores a language model that is trained to break a task down into subcomponents. Additionally, Node A stores logic that is capable of calling an external function 204. The node-specific base context 202a includes a set of instructions that ask the language model to break down a user request 214 into three components: 1. What item is being asked for? 2. Where is the item? And 3. What is the goal of the user request? Once the language model translates the user request into these three things, Node A executes the function 204, which retrieves the robot's current location.

If, for example, the user request 214 says “Get the radio,” the language model within node A processes the request in view of the node-specific base context 202a and returns all of: 1. Radio (e.g., the object requested); 2. Common space (e.g., a likely location for a radio); and 3. Get Radio (the goal). Node A then retrieves the user's current location, appends this to the language model outputs (1-3 above), and selects another node in the HELM system 200 to receive these outputs.

In one implementation, each node in the HELM system 200 selects the destination for its output by executing locally-stored output management instructions, as generally described with respect to claim 1. For example, the output management instructions for Node A may list the node-specific base contexts 202b, 202c, and 202d (e.g., the nodes with direct connectivity to node A) and also include a prompt that instructs the language model of Node A to select one of the Nodes B, C, and D for which the corresponding node-specific base context appears most relevant to the remaining processing tasks identified within the request data.

For instance, in the above-described example, Node A generates outputs including: 1. Radio; 2. Common space; 3. Get Radio; and 4. Robot's current location. In response, the language model of Node A selects Node C to receive the outputs because the node-specific base context 202c of Node C mentions a “radio” and “common space.”

In the example shown, Nodes B, C, and D store instances of generative AI language models that are capable of processing natural language and generating answers to natural language questions. Each of these nodes is designed to “get the location” of recognized items named in its input. In the simplified example shown, the nodes B, C, and D each have the capability of locating objects in a different respective room of the home. The node-specific base context 202b of Node B identifies where certain objects are located in the user's kitchen; the node-specific base context 202c of Node identifies where certain objects are located in the user's common space, and the node-specific base context 202d identifies where certain objects are likely to be found in the user's bathroom.

If, in the above example of the “get radio” user request, Node A passes its outputs to Node C. Thus, Node C receives inputs that include: “radio”, “common space”, “get radio”, and the robot's current location. Node C passes these inputs to its language model along with the node-specific base context 202c, which instructs the language model to “get the likely location for the item and pass the information through.” The node-specific base context 202c additionally lists the locations of various objects in the common space of the user's home. The language model of Node C analyzes the user inputs to determine that its objective to “get radio” and, based on the node-specific base context 202c, determines that the radio is on the table. Node C appends this information (“radio is on the table in the common space”) to the inputs that it receives and then determines where to send this combined data.

Node C executes its own output management instructions (not shown) to select the node that is to receive its outputs. In the HELM system 200, the node-to-node connectivity is restricted to pass all outputs of Node C flow to Node E, so there exists a single output destination to select. In another implementation, the output management instructions of Node C may include conditional instructions, such as “select the outputs to whichever node is most likely to be able to find remaining unlocated items. If all items have been found, direct the outputs to Node E.”

Node E stores a language model that can translate natural language commands into action function calls (e.g., for functions 208 and 210) and execute those function calls to generate control signals that ambulate a robot around the home and move the robot to interact with objects. Upon receiving a set of inputs, Node E passes the received inputs to its language model along with an instruction such as “navigate to and get the item. Say if you got the item.” In the above example where the user request 214 is “get radio,” Node E receives inputs identifying the user request 214 and the information “radio is on the table in the common space.” Based on this, Node E constructs and executes a function calls to the function 210 (“Go to Item”) and the function 208 (“collect item”). Node E generates a request response 216 that informs the user: “I have the radio.”

Although not shown in FIG. 2, the HELM system 200 further includes a context updater that autonomously updates the node-specific base context of select nodes in response to performance issues that the system experiences and self-detects. If, for example, the HELM system 200 is unable to find a requested object, the context updater 224 may conduct an analysis to determine why the requested object could not be found and, if appropriate, implement update(s) to the node-specific base context of one or more of the system nodes to ensure that the unlocatable object can be found if and when the user requests it again in the future. The functionality of the context updater is discussed in greater detail with respect to FIG. 3. The analysis may be computed using rules or by querying a generative machine learning model.

FIG. 3 illustrates a context updater 324 that performs operations to autonomously update the node-specific base context of select nodes of an example HELM system 300. The HELM system 300 includes a node network 301 with a plurality of nodes. Each node in the node network 301 stores a node-specific base context (not shown) and an instance of a language model. The nodes may store other data and logical components, including data and logical components described with respect to the nodes of FIG. 1 or 2.

The context updater 324 includes multiple different software components (“agents”) that interact with various language models 326 to perform context-update operations. In FIG. 3, these agents are shown to include a conversation history evaluation agent 304, a root cause investigation agent 306, and a base context modification agent 310.

The context updater 324 periodically executes the context-update operations, described below, to update the node-specific base context of select nodes within the node network 301. In various implementations, the context updater 324 performs the context-update operations in response to different event triggers, such as at the conclusion of each different user session (e.g., conversation) with the HELM system, at scheduled periodic intervals, or in response to a manual request by a user.

As input, the context updater 324 receives two inputs-conversation history data 330 and a node chain metadata log 340, both of which are generated by the node network 301 during processing of user inputs. The conversation history data 330 includes sequential user requests received and processed by the node network 301. In implementations where the node network returns text output to the user, the conversation history 330 may additionally include responses that the node network 302 returns to the user in response to processing each user request.

In the example of FIG. 3, the conversation history data 330 is shown to exclusively include a sequence of user request input to the node network 301 and does not show system-generated outputs. In this example, the node network 301 is assumed to have the arrangement of nodes and node characteristics shown and described with respect to FIG. 2. The conversation history data 330 includes four sequentially-provided user requests including:
1. “Bring me a towel.”
2. “Go get the radio.”
3. “Thanks. Now I'd like a cup of water.”

### 4. “you Did Not Get me a Cup of Water!”

The node chain metadata log 340 stores metadata generated by the system's nodes during the processing of each user request. This metadata identifies a master chain of actions performed in association with the processing of each user request as well as the node that performed each action. The actions logged include the functions called by the node, external calls placed, and the input(s) and output(s) to each action.

During nominal operations of the node network 301, the node network 301 receives and processes user requests, such as those shown in the conversation history data 330. Each received user request is propagated through a chain of nodes that perform different sub-tasks relating to the request, as generally described with respect to FIGS. 1 and 2. Once all relevant sub-tasks have been completed, a request response is returned to the user. In some implementations, the request response includes data generated by the HELM system 300 that is visually or audibly presented to the user, such as on a display of a computing device implementing one or more of the system nodes. In other implementations, the request response alternatively or additionally includes the execution of a movement or control action. For example, a robot performs an action that the user has requested or a computer automation assistant moves a file to a requested location.

During the context-update operations illustrated in FIG. 3, the context updater 324 first evaluates the conversation history data 330 of the HELM system to identify one or more user requests that convey negative sentiment, such as statements that are generally indicative of user disappointment, dissatisfaction, frustration, anger, etc.

In one implementation, the context updater 324 delegates this sentiment analysis to a sentiment analysis model 328. The sentiment analysis model 328 is a machine learning model that analyzes text to determine the underlying emotional tone or sentiment. Sentiment analysis is widely used in areas like social media monitoring, customer feedback analysis, and market research to gauge public opinion or customer satisfaction. In one implementation, the sentiment analysis model 328 is trained on a large dataset of text samples that reflect the types of statements and/or sentiments that the model will analyze (e.g., commands verbally given to an in-home robotic assistant). Each text sample in the dataset is labeled with its sentiment.

When provided with statements 1-4 of the conversation history data 330, the sentiment analysis model 328 detects negative sentiment (“dissatisfaction”) in statement number 4, which reads: “You did not get me a cup of water!”

In another implementation, the conversation history evaluation agent 304 performs the above-described sentiment analysis by passing the conversation history data 330 to a semantic similarity model 332 that evaluates the relative similarity of pairs of the sequentially received user requests in the conversation history data 330. In this case, the conversation history evaluation agent 304 determines that a particular user request conveys negative sentiment when the request satisfies a similarity threshold with another, immediately-received prior user statement. Assume, for example, that a user instructs the HELM system to: “Go perform XYZ.” Further assume that immediately following this, the next two requests the user makes are “Go perform X” and “Ok. Now go perform YZ.” In this scenario, the user has broken down the initial request (“go perform XYZ”) into two supplemental requests that individually include different respective sub-components of the original request. When a scenario like this is observed, it is often reasonable to assume that the original request did not yield the expected output. Therefore, a request that is repeated, in full or in part, is likely to be a request that is implicitly indicative of negative sentiment.

To identify user requests that have been rephrased or repeated as generally described above, the semantic similarity model 332 computes a similarity metric for consecutively-received pair of user inputs within the conversation history data 330. This similarity metric quantifies the similarity of inputs in terms of meaning, regardless of the specific words used. Semantic similarity models typically convert text into embeddings—numerical vectors that represent meaning. Embeddings are created by models like Word2Vec, GloVe, or Transformer-based models like BERT and GPT. Once the text is converted into embeddings, the model can measure similarity by calculating the cosine similarity or Euclidean distance between these vectors. Similar meanings result in embeddings that are close in this vector space.

In the example shown, there are no repeated or rephrased user requests within the conversation history data 330. Depending on the similarity threshold enforced by the semantic similarity model 332, statements 3 and 4 might be flagged as satisfying a similarity threshold because both reference “water” in immediate succession. Thus, by employing either the semantic similarity model 332 or the sentiment analysis model 328 as described above, the conversation history evaluation agent 304 may be able to determine that statement #4 is indicative of negative sentiment (user dissatisfaction).

In response to identifying a particular user request (statement #4) that is indicative of a negative sentiment, the conversation history evaluation agent 304 next attempts to identify which request in the conversation history data 330 served as the nexus for the negative sentiment. It is assumed that the user experienced the negative sentiment due to receiving an unexpected output in response to a previous request. This previous request is referred to herein as an “unfulfilled request” (e.g., the unfulfilled request 305) because the processing of this request yielded unexpected output-meaning, the request was not fulfilled in the manner that the user deemed to be satisfactory. In one implementation, the conversation history evaluation agent 304 is configured to identify the user statement immediately preceding the expression of negative statement as the “unfulfilled request.” In the example shown, statement #4 conveys the negative sentiment and statement #3 is identified as the unfulfilled request 305.

In some scenarios, the conversation history evaluation agent 304 identifies the unfulfilled request based on an analysis of responses returned to the user without employing the sentiment analysis model 328 or the semantic similarity model 332. For example, the HELM system may include a chat interface that responds to statement #3 in the above example with the text: “I could not find the water.” In this example, the performance shortcoming of the HELM system can be identified exclusively via a plain language analysis of the output “I could not find the water.” It is worth noting, however, that there could likewise exist scenarios where the request response does not indicate a problem that the user is plainly aware of. For example, the robot might bring the user a banana in response to a request for water and tell the user: “here is the water.” In this scenario, the unfulfilled request 305 is better identified via the above-described sentiment analysis of user inputs.

The conversation history evaluation agent 304 passes an identification of the unfulfilled request (e.g., statement #3) to the root cause investigation agent 306, which in turn performs investigative operations to identify why the unexpected output was generated. The root cause investigation agent 306 begins this analysis by parsing the node chain metadata log 340 to determine whether any exceptions were raised during the processing of the unfulfilled request 305. In programming, the term “exception” refers to an event or error that occurs during the execution of a program that disrupts the normal flow of instructions. When an exception arises, it typically means something went wrong, like an unexpected condition or a problem that the program was not designed to handle. Many programming languages provide built-in mechanisms that raise exceptions in various scenarios. Examples of common exceptions include “file not found” (e.g., when attempting to open a file that does not exist or is inaccessible), invalid input” (e.g., when receiving data that doesn't match the expected types or formats), “timeout error” (e.g., when waiting to long for a network response); “IOError” (e.g., raised for input/output errors, such as issues with file handling or when a disk is full and cannot be written to), and many more. Programmers commonly draft code using techniques to ensure that exceptions are logged or otherwise presented to the end user, which allows that individual to investigate the root cause of each exception raised and based on such investigation, modify the code to make it more robust to the types of scenarios that caused the exceptions to be raised.

In an implementation where the node network 301 includes the architecture shown and described with respect to FIG. 2, the root cause investigation agent 306 parses the node chain metadata log 340 to determine what went wrong when processing the request “I'd like a glass of water.” The root cause investigation agent 306 determines that Node E executed the actions “Go to Kitchen” and “Get Cup,” before logging an exception: “Exception! Water not found.” Following this, Node E executed the action “Collect Cup” (and failed to collect the water, as the user requested).

After identifying the exception raised by Node E during the processing of the unfulfilled request, the root cause investigation agent 306 next attempts to identify a rationale for the exception raised, referred to herein as a root cause descriptor 309, such as by identifying a specific piece of information that was needed by and not available to the node that raised the exception. In one implementation, the root cause investigation agent 306 employs a language generation model 344 to generate a descriptor that identifies a root cause of the exception. The language generation model 344 is, for example, a general-purpose natural language processing model such as a GPT model, OPT model, or BERT model.

As an example of the above, the root cause investigation agent 306 passes the language generation model 344 a set of inputs that includes: 1. the unfulfilled request (e.g., “I'd like a glass of water”); 2. the inputs provided to the node that raised the exception; 3. the metadata generated by the node that raised the exception (e.g., the actions executed by node and their respective inputs and outputs); and 4. an instruction that says: “use items 2 and 3 to determine why the exception was raised.” Assume that in this example, the inputs (2) provided to Node E included “cup in the kitchen” and “get cup of water.” In this scenario, the language generation model 344 analyzes the inputs in view of the language of the exception (2), which reads: “Exception! Water not found!” In response, the language generation model 344 and outputs a root cause descriptor 309 that identifies a root cause of the exception. The root cause descriptor 309 identifies the missing information that was needed by the system but unavailable. In this example, the descriptor reads “the location of the water was not provided” because the inputs to Node E did not identify the location of the water, which was needed to fulfill the user request.

Upon receiving the root cause descriptor 309 (e.g., “location of water not provided”) from the language generation model 344, the root cause investigation agent 306 next selects a node, referred to in the following description as “the responsible node”, that is to be responsible for supplying the missing information (e.g., “location of water”) in the event that this information is again needed to process another user request in the future. To identify the responsible node, the root cause investigation agent 306 analyzes the node-specific base context of each node that processed sub-task(s) for the unfulfilled request 305 to identify which node is best suited to retrieve the missing information.

Assume, for example, that the unfulfilled request 305 (“I'd like a glass of water request”) was sequentially processed by Nodes A, B, and E that are shown and described with respect to FIG. 2. Further assume that Node E raised the exception. In this scenario, the root cause investigation agent 306 reviews the node-specific context of nodes A and B to determine which node should have been responsible for supplying the missing information - that is, which node is capable of performing sub-tasks most closely related to retrieving the missing information? In one implementation, this analysis is delegated to a topic similarity model 346 that is trained to measure how similar or related two pieces of text are based on the topics or themes they cover. For example, the topic similarity model 346 encodes different portions of a hierarchical ontology as different embeddings in the latent space, with spatial proximity between pairs of the embeddings being correlated with similarity between the associated topics.

In one implementation, the root cause investigation agent 306 passes the topic similarity model 346 a set of inputs that includes 1. the root cause descriptor 309 (e.g., “location of water not provided”); 2. the node-specific base context of each node in the chain that processed the unfulfilled request 305 (e.g., the node-specific base contexts of Node A and Node B of FIG. 2); and 3: an instruction that reads: “Use the information listed in (2) to determine which node has a node-specific base context most similar to the missing information identified in (1).” In this scenario, the topic similarity model 346 determines that the topics identified in the missing information include: “location” and “water.” The topic similarity model 346 further determines that Node B is capable of retrieving “locations” (a topical match to the missing information). and these locations may be for items in a “kitchen” (a topic that is related to “water” because water is found in the kitchen). Based on this and the fact that a lesser degree of similarity is identified during a similar analysis performed with respect to Node A, the topic similarity model 346 outputs “Node B.” Consequently, Node B assumed to be the node responsible for supplying the missing information (“the responsible node 307”).

Once the responsible node 307 is selected, the root cause investigation agent 306 provides the base context modification agent 310 with inputs that identify the responsible node 307 (e.g., “Node B”) and the root cause descriptor 309 (e.g., the descriptor reading: “location of water not provided”). The base context modification agent 310 is tasked with determining how the node-specific base context of the responsible node can be updated to ensure that missing information identified within the root cause descriptor 309 (e.g., “the location of water”) can and will be obtained by the responsible node 307 in the event that this information is again needed to process a user request in the future.

In one implementation, the task of determining how to update a node-specific base context is delegated to a retrieval generation assistant (RAG) assistant 348 that communicates with the language generation model 344 to carry out instructions of the base context modification agent 310. The RAG assistant 348 has the capability of searching multiple databases, document repositories, or knowledge bases to retrieve information relevant to answering a received query. Once identified, the relevant information is passed, along with the received query to a back-end model (e.g., the language generation model 344), which is instructed to use the relevant information to answer the query.

To determine how to update the node-specific base context of the responsible node, the base context modification agent 310 passes the RAG assistant a set of inputs that includes: (1) the node-specific base context of the responsible node (e.g., 202b in FIG. 2); (2) the root cause descriptor 309 (e.g., “location of water not found”); and (3) an instruction that reads: “modify the text in (1) to additionally include the missing information identified in (2). Upon receiving this set of inputs, the RAG assistant 348 searches its source index for information relevant to answering the question “where is water located?” Per this search, the RAG assistant 348 successfully identifies one or more data chunks (documents or portions of documents) relevant to the missing information (e.g., the location of water). For example, the RAG assistant 348 may search a database (initially configured by the user) and find an appliance manual or plumbing information pertaining to the user's home. Notably, in this simplified example it is possible that the language generation model 344 would correctly identify where to “find water” in a home even if not passed relevant reference materials. However, other actual implementations of the above may relate to more complicated questions that cannot necessarily be answered by the training dataset of the language generation model 344.

The RAG assistant 238 passes the retrieved relevant information (data chunks) to the language generation model 344 along with all information in the original request (1-3) and prompts the language generation model 344 to use the relevant information to answer the original request. In response, the language generation model 344 uses the relevant information to find the missing information (e.g., the location of water) and outputs a modified (updated) version of the node-specific base context that it received as input (e.g., as part of (1), above). This modified version is, for example, identical to the original (e.g., as shown in 202b of FIG. 2) but additionally includes the information: “water is in the refrigerator door.” The base context modification agent 310 replaces the node-specific base context of the responsible node 307 with the updated, modified version output by the language generation model 344.

Per the above-described operations, the node-specific base context of the responsible node 307 has been autonomously updated to include new, additional information that expands the capabilities of the node and thereby mitigates the likelihood of the same exception (“water not found!”) being raised within the node network 302 in the future. In this way, the node-specific base contexts of the nodes can be gradually and incrementally updated over time, increasing the capabilities of each respective node and the HELM system 300 as a whole.

FIG. 4 illustrates an example node network within a HELM system 400 with nodes that execute logic for autonomously splitting themselves into two or more nodes when the node-specific base context in the node is determined to satisfy splitting criteria. In FIG. 4, the node network of the HELM system 400 is shown at three different consecutive points in time 404, 406, and 408. During this sequence, a node 410 (shown at time 404) self-divides into two nodes 412 and 414, as shown at time 406. Following this split, node-to-node connections are re-established, as shown at time 408.

Although not shown in FIG. 4, each of the nodes in the HELM system 400 stores a node-specific base context (as described with respect to FIG. 1-3) and splitting instructions (as discussed generally with respect to FIG. 1). Additionally, the HELM system 400 includes a context updater (also not shown) that executes logic to autonomously update the node-specific base context of select nodes in the system over time to gradually refine and expand the capabilities of individual nodes, such as according to the logical operations generally described above with respect to FIG. 3. Consequently, the node-specific base context of an individual node, such as the node 410, may grow in length from one or two initial directives (e.g., a short sentence or a couple of sentences) to tens or hundreds of directives (e.g., paragraphs or pages of text).

To exemplify the above, assume that the node 410 performs semantic retrievals for programming assistance. Initially, the node 410 has a node-specific base context that reads: “Summarize the text you receive and pull the most important semantic information to help the user understand how to run commands in a command line.” Then, over time, the user of the HELM system 400 asks many questions about GIT commands, and the node-specific base context of the node 410 is autonomously updated (as described with respect to FIG. 3) to help the node 410 more accurately pull and summarize useful information pertaining to execution of GIT commands. Further, assume that the user takes on a new development project and begins asking the HELM system questions about Web API commands. As more time passes, the node-specific base context of the node 410 is autonomously updated to include a number of instructions that help the node 410 more accurately pull and summarize useful information about running Web API commands. As the node-specific base context of the node 410 grows to encompass information pertaining to several sub-topics (all related to running commands in a command line), the node 410 continues passing all of the node-specific context to its language model each time a new input is received at the node 410. At this point in time, the performance of the language model may degrade a bit since language models typically perform worse when provided with longer sets of instructions. It is known that when the instructions become excessively long, language models are more likely to “miss” key instructions and also hallucinate answers that are not relevant. For this reason, it is beneficial to enforce logic that enables the node 410 (and all other nodes in the HELM system 400) to autonomously divide into multiple nodes when the stored context of a given node satisfies split criteria (discussed below). Following a split of a node into multiple nodes, each of the multiple nodes stores a different subset of the node-specific base context that was stored by the node prior to the split.

In the HELM system 400, each of the nodes includes a node controller that periodically evaluates the locally-stored node-specific base context in view of the locally-stored splitting instructions to determine whether or not the node-specific base context satisfies split criteria defined within the splitting instructions.

In one implementation, the split criteria is length-based. For example, the splitting instructions direct the node controller to split the node 410 into two nodes in response to determining that the node-specific base context exceeds a set number of characters or words. In this implementation, the splitting instructions may set forth further directives that tell the node controller how and where to split the node-specific base context. For example, the splitting instructions may instruct the node controller to analyze topics within the node-specific base context, determine pairs of topics that satisfy a dissimilarity threshold, and split the node-specific base context into multiple portions that each store text pertaining to a respective subset of the topics determined to satisfy the dissimilarity threshold with the topics included in the other portion.

Topic divergence can, for example, be assessed by passing the node-specific base context to a topic modeling algorithm and then using a sentence transformer model to embed the topics extracted and compute similarity between extracted topics. One example of a topic modeling algorithm is Latent Dirichlet allocation (LDA), which works by using co-occurrence patterns to identify a set of topics that best represent the text. One example of a sentence transformer model is BERT, which is capable of translating words or sentences (topics) into embedding and then computing similarity between those words or sentences by computing a dot product or cosine similarity for individual pairs of the embeddings.

In another implementation, topic divergence is assessed without the above-described topic-extraction step. For example, each line of the text in the node-specific base context can be directly embedded by a sentence transformer model, and the different lines of text can be compared for similarity by computing a cosine similarity or dot product of the corresponding embeddings. Based on the outputs of the above-described analysis, the node controller can identify topics or lines of text that differ by a greater than a threshold amount. In some implementations, the splitting instructions provide guidelines for splitting the node-specific base context after the dissimilar topics or sentences have been are determined to satisfy a dissimilarity threshold when compared to one another but no other pair of the remaining topics satisfies the dissimilarity threshold, a similarity analysis may be performed to match the remaining topics with a select of the two topics that are to be “split” from one another and stored in different nodes. For example, each of the remaining topics is grouped with whichever one of the two topics it is semantically closest to.

In yet still another implementation, the split criteria is topic-based rather than length-based. For example, the splitting instructions may instruct the node controller to periodically evaluate topic divergence (e.g., per either of the above-described methods) and split the node-specific base context when the node-specific base context includes a set number of topics or sentences that differ from one another by more than a threshold amount. If, for example, any two topics or sentences are determined to satisfy a dissimilarity threshold when compared to one another, the node is to be split using those two topics or sentences as “anchors” assigned to different nodes following the split. In this case, further semantic similarity analysis is performed to identify how and where to split the other topics or sentences that did satisfy the dissimilarity threshold relative to any other topics or sentences analyzed.

To exemplify this, assume the node 410 has a node-specific base context that includes instructions that pertain to topics A, B, C, D. Topics A and C are determined to satisfy a dissimilarity threshold but no other pair of the identified topics satisfies the dissimilarity threshold. In this case, each of topics B and D is then compared to each of A and C to determine which is a “more similar” match. When B is determined to be more similar to A than C, B is grouped with A. When D is determined to be more similar to C than A, then D is grouped with C. Following this analysis, the node 410 is split into nodes 412 and 414. Node 412 is initialized to store a first subset of the node-specific base context for node 412 that includes all text related to topics A and B. Node 414 is then initialized to store a second subset the node-specific base context for node 412 that includes all text related to topics C and D.

When the node 410 autonomously splits into nodes 412 and 414, node-to-node connections are reestablished. In the example shown, each of the nodes 412 and 414 is initialized with the same node map, which may, for example, store the same type of information discussed with respect to the node map of FIG. 1. Because nodes 412 and 414 store an identical node map, each of the nodes 412 and 414 is capable of selectively passing its respective outputs to a same set of system nodes (e.g., a set that includes nodes 416, 418, and 420). Following the split, the nodes 412 and 414 store identical instances of the language model stored in the node 410 prior to the split, as well as identical instances of the node controller.

This splitting functionality ensures that the individual nodes in the HELM system 400 perform with a consistent degree of accuracy as the node-specific base context within each node grows and becomes more specialized. Specifically, this splitting serves to limit the quantity of instructions passed to the language model within the node, which reduces the likelihood of model hallucinations and missed instructions that produce undesired or inaccurate outputs.

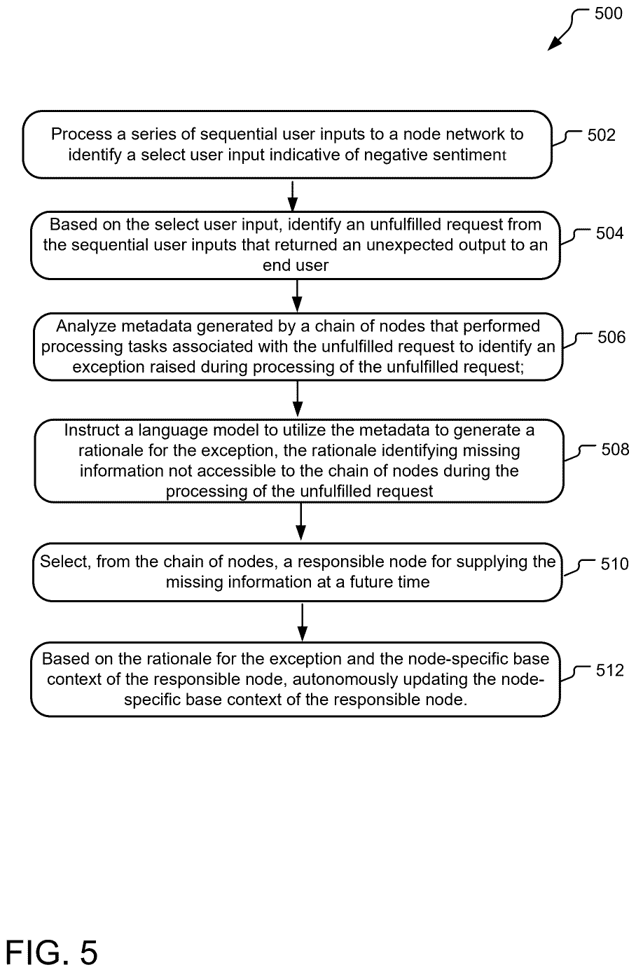

FIG. 5 illustrates example context update operations 500 for autonomously updating the node-specific base context of a node within a HELM system implementing the herein-disclosed technology. The HELM system includes a network of nodes that each store a language model and a node-specific base context. The node-specific base context provides at least one instruction that the language model is instructed to follow when processing inputs. The HELM network additionally includes a context updater that performs context update operations 500. These operations include a processing operation 502 that processes a series of sequential user inputs provided by a user to the node network to identify a select user input indicative of negative sentiment. In one implementation, the processing operation 502 entails analyzing the series of sequential user inputs by a sentiment analysis model that is trained to determine or classify a sentiment most relevant to each user input. The “select user input” is the user input that is classified as conveying or indicating the most negative sentiment of the inputs analyzed.

An identification operation 504 provides for identifying, from the sequential user inputs, a request that was not fulfilled as expected by the user - referred to as an “unfulfilled request.” This unfulfilled request is selected based, at least in part, on the user request identified as conveying the negative sentiment. In one implementation, the unfulfilled request is a request within the sequence of user inputs that immediately precedes the request identified as conveying the negative sentiment.

A metadata analyzes operation 506 analyzes metadata generated by a chain of nodes that performed processing tasks associated with the unfulfilled request to identify an exception raised during processing of the unfulfilled request.

A descriptor-generating operation 508 instructs a language model to utilize the metadata to generate a root cause descriptor that identifies the root cause of the exception (e.g., provides a rationale for the description), the root cause descriptor including information that was needed by a node and unavailable to that node during the processing of the unfulfilled request. In one implementation, generating the root cause descriptor entails directing a language model to generate the root cause descriptor based on context of the unfulfilled request and metadata generated by the chain of nodes.

A selection operation 510 selects, from the chain of nodes, a responsible node for supplying the missing information at a future time. In one implementation, the selection operation entails a semantic comparison (e.g., by a semantic similarity model) between the root cause descriptor and the node-specific context of one or more nodes within the chain of nodes that performed some processing in relation to the unfulfilled request. The node having the node-specific base context most similar to the root cause descriptor is selected as the responsible node.

An autonomous update operation 512 entails autonomously updating the node-specific base context of the responsible node based on the root cause descriptor and the node-specific base context of the responsible node. In one implementation, the autonomous update operation 512 entails instructing the language model to generate an updated version of the node-specific context for the responsible node that identifies the missing information (or how to find the missing information) that is identified within the root cause descriptor for the exception.

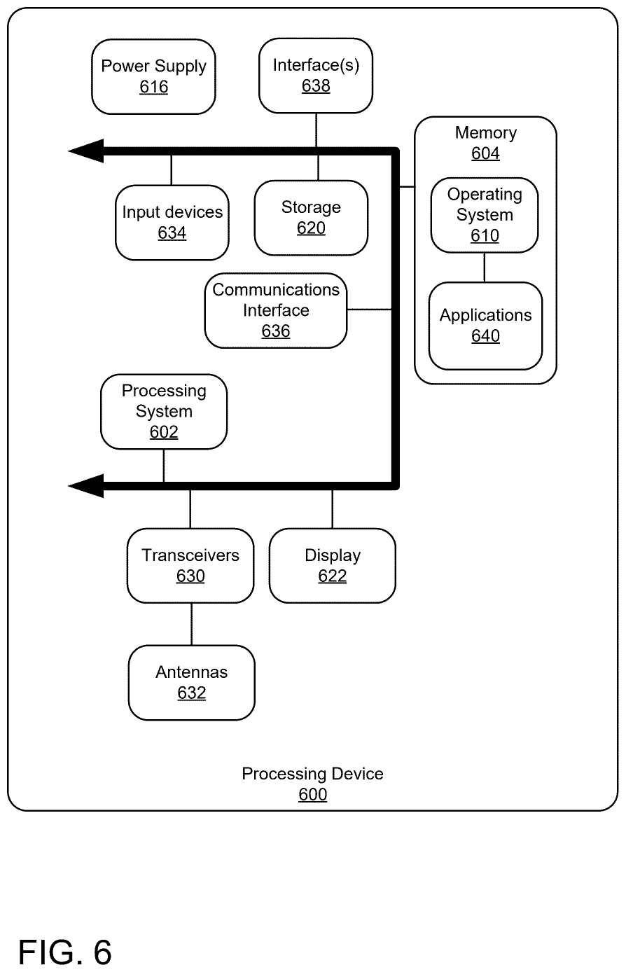

FIG. 6 illustrates an example schematic of a processing device 600 suitable for implementing aspects of the disclosed technology. The processing device 600 includes a processing system 602, memory 604, a display 606, and other interfaces 608 (e.g., buttons). The processing system 602 may include one or more CPUs, GPUs, etc. The processing device 600 may be a client computing device (such as a laptop computer, a desktop computer, or a tablet computer), a server/cloud computing device, an Internet-of-Things (IoT), any other type of computing device, or a combination of these options.

The memory 604 generally includes both volatile memory (e.g., RAM) and nonvolatile memory (e.g., flash memory), although one or the other type of memory may be omitted. An operating system 610 resides in the memory 604 and is executed by the processing system 602. In some implementations, the processing device 600 includes and/or is communicatively coupled to storage 620.

In the example processing device 600, as shown in FIG. 6, one or more software modules, segments, and/or processors, such as applications 650 (e.g., language models, a context updater, a node controller or other executable logic of nodes within a HELM system 100) are loaded into the operating system 610 on the memory 604 and/or the storage 620 and executed by the processing system 602. The storage 620 may store historical resource utilization data for customers of a cloud platform as well as customer-specific detection parameters used to predict customer usage and set detection thresholds.

The processing device 600 may include one or more communication transceivers 630, which may be connected to one or more antenna(s) 632 to provide network connectivity (e.g., mobile phone network, Wi-Fi®, Bluetooth®) to one or more other servers, client devices, IoT devices, and other computing and communications devices. The processing device 600 may further include a communications interface 636 (such as a network adapter or an I/O port, which are types of communication devices) that is used to establish connections over a wide-area network (WAN) or local-area network (LAN). It should be appreciated that the network connections shown are exemplary and that other communications devices and means for establishing a communications link between the processing device 600 and other devices may be used.

The processing device 600 may include one or more input devices 634 such that a user may enter commands and information (e.g., a keyboard, trackpad, or mouse). These and other input devices may be coupled to the server by one or more interfaces 638, such as a serial port interface, parallel port, or universal serial bus (USB). The processing device 600 may further include a display 622, such as a touchscreen display.

The processing device 600 may include a variety of tangible processor-readable storage media and intangible processor-readable communication signals. Tangible processor-readable storage can be embodied by any available media that can be accessed by the processing device 600 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes but is not limited to RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the processing device 600. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

In some aspects, the techniques described herein relate to a system including: a plurality of nodes that each include a generative machine learning model and a node-specific base context storing at least one instruction that the generative machine learning model is instructed to follow when processing inputs; a context-updater stored in memory and including code that is executable to: analyze metadata generated by a chain of nodes of the plurality of nodes that processed a user request to identify an exception raised by a select node during processing of the user request; instruct a generative machine learning model to utilize the metadata to generate a root cause descriptor that identifies a root cause of the exception, the root cause descriptor identifying information not accessible to the chain of nodes during the processing of the user request; select, from the chain of nodes, a responsible node for supplying the information at a future time; and based on the root cause descriptor identifying the root cause of the exception and the node-specific base context of the responsible node, update the node-specific base context of the responsible node to include the information without user input.

In some aspects, the techniques described herein relate to a system, wherein the context-updater is further executable to: analyze a series of sequential user inputs received by the system to identify a select user input indicative of negative sentiment; and based on the select user input indicative of negative sentiment, identify an unfulfilled request from the sequential user inputs, wherein the user request is the unfulfilled request.

In some aspects, the techniques described herein relate to a system, wherein the responsible node receives a request and generates a request response automatically triggering the execution of a movement of a physical robot or a control action of a computer automation assistant.

In some aspects, the techniques described herein relate to a system, wherein the context-updater selects the responsible node by operations that include: instructing a topic similarity model to identify the responsible node within the chain of nodes, the node-specific base context of the responsible node being more similar to the root cause descriptor for the exception than the node-specific base context of each other one of the plurality of nodes.

In some aspects, the techniques described herein relate to a system, wherein a node of the plurality of nodes further includes: splitting instructions stored by the node that define split criteria for splitting the node into two separate nodes; a node controller within the node that: evaluates the node-specific base context of the node in view of the splitting instructions to determine whether the split criteria are satisfied; and in response to determining that the split criteria are satisfied, split the node-specific base context of the node into a first subset and a second subset; splits the node into a first node and a second node, the first node having a first node-specific base context that equals the first subset and the second node having a node-specific base context that equals the second subset;

In some aspects, the techniques described herein relate to a system, wherein the split criteria provide for splitting the node in response to determining that the node-specific base context stores topics that satisfy a dissimilarity threshold when compared to one another, and wherein evaluating the split criteria includes: providing portions of the node-specific base context as input to a generative machine learning model that generates embeddings of the portions and computes a relative similarity between each pair of the embeddings.

In some aspects, the techniques described herein relate to a system, wherein the context-updater autonomously updates the node-specific base context of the responsible node by performing operations that include: providing a generative machine learning model with the node-specific base context of the responsible node, the root cause descriptor for the exception, and an instruction to modify the node-specific base context to include the information identified in the root cause descriptor for the exception.

In some aspects, the techniques described herein relate to a system, wherein the context-updater identifies the select user input indicative of negative sentiment by operations that include: instructing a semantic similarity model to assess similarity of consecutively-received pairs of user inputs within the series of sequentially-received user input, wherein the select user input satisfies a similarity threshold with a previously-received input.

In some aspects, the techniques described herein relate to a system, wherein the context-updater identifies the select user input indicative of negative sentiment by operations that include: instructing a sentiment analysis model to determine a sentiment associated with each user input in the series of sequentially-received user inputs, the select user input being identified by the sentiment analysis model as conveying the negative sentiment.

In some aspects, the techniques described herein relate to a system, wherein a first node of the plurality of nodes further includes: output management instructions that instruct the generative machine learning model of the first node to select another node from the plurality of nodes to receive outputs from the first node; and a node controller that receives a user input and, in response, provides the generative machine learning model of the first node with a set of inputs including the user input, the node-specific base context, and the output management instructions, and wherein the first node generates an output in response to processing the user input, the output designating a next node selected from the plurality of nodes to receive and process the user input.

In some aspects, the techniques described herein relate to a method including: analyzing metadata generated by a chain of nodes that performed processing tasks associated with a user request to identify an exception raised during processing of the user request, the chain of nodes being included within a node network and each including a generative machine learning model and a node-specific base context storing at least one instruction that the generative machine learning model is instructed to follow when processing inputs; instructing a generative machine learning model to utilize the metadata to generate a root cause descriptor identifying a root cause of the exception, the root cause descriptor identifying information not accessible to the chain of nodes during the processing of the user request; selecting, from the chain of nodes, a responsible node for supplying the information at a future time; and based on the root cause descriptor for the exception and the node-specific base context of the responsible node, autonomously updating the node-specific base context of the responsible node to include the information.

In some aspects, the techniques described herein relate to a method, wherein the user request is an unfulfilled request and the method further includes: processing a series of sequential user inputs provided by a user to the node network to identify a select user input indicative of negative sentiment, the node network including a plurality of nodes; based on the select user input, identifying the unfulfilled request from the sequential user inputs that returned an unexpected output to the user.

In some aspects, the techniques described herein relate to a method, wherein selecting the responsible node includes: instructing a topic similarity model to identify the responsible node within the chain of nodes, wherein the node-specific base context of the responsible node is more similar to the root cause descriptor identifying the root cause of the exception than the node-specific base context of each other node in the node network.

In some aspects, the techniques described herein relate to a method, wherein a node in the node network further includes: splitting instructions stored by the node that define split criteria for splitting the node into two separate nodes, wherein the method further includes: evaluating the node-specific base context of the node in view of the splitting instructions to determine whether the split criteria are satisfied; and in response to determining that the split criteria are satisfied, splitting the node-specific base context of the node into a first subset and a second subset, wherein the method further includes 15. splitting the node into a first node and a second node, the first node having a first node-specific base context that equals the first subset and the second node having a node-specific base context that equals the second subset.

In some aspects, the techniques described herein relate to a method, wherein the split criteria provide for splitting the node into multiple nodes in response to determining that the node-specific base context stores topics that satisfy a dissimilarity threshold when compared to one another, and wherein evaluating the split criteria includes providing portions of the node-specific base context as input to a generative machine learning model that generates embeddings of the portions and computes relative similarity between each pair of the embeddings.

In some aspects, the techniques described herein relate to a method, wherein autonomously updating the node-specific base context of the responsible node includes providing a generative machine learning model with the node-specific base context of the responsible node, the root cause descriptor, and an instruction to modify the node-specific base context to include the information identified in the root cause descriptor.

In some aspects, the techniques described herein relate to a method, wherein processing the series of sequential user inputs to identify the select user input indicative of negative sentiment further includes a select one of: instructing a semantic similarity model to assess similarity of consecutively-received pairs of user inputs within the series of sequential user inputs, wherein the select user input satisfies a similarity threshold with a previously-received input; or instructing a sentiment analysis model to determine a sentiment associated with each user input in the series of sequentially-received user inputs, the select user input being identified by the sentiment analysis model as conveying the negative sentiment.

In some aspects, the techniques described herein relate to one or more tangible computer-readable storage media encoding processor-executable instructions for executing a computer process, the computer process including: receiving a series of sequential user inputs at a node network, the node network including a plurality of nodes that each include a generative machine learning model and a node-specific base context storing instructions that the generative machine learning model is instructed to follow when processing inputs at each node; identifying, with a sentiment analysis model, a select user request within the series that conveys a negative sentiment; identifying an unfulfilled request from the series of sequential user inputs, the unfulfilled request being request received immediately prior to the select user request; identifying an exception raised during processing of the unfulfilled request within metadata generated by a chain of nodes within the node network; instructing a first generative machine learning model to utilize the metadata and the unfulfilled request to generate a root cause descriptor identifying a root cause of the exception, the root cause descriptor identifying information not accessible to the chain of nodes during the processing of the unfulfilled request; selecting, from the chain of nodes, a responsible node for supplying the information at a future time; and providing a second generative machine learning model with a node-specific base context of the responsible node, the root cause descriptor, and an instruction to modify the node-specific base context to include the information identified in the root cause descriptor; receiving an updated version of the node-specific base context as output from the responsible node; and overwriting the node-specific base context of the responsible node with the updated version of the node-specific base context.

In some aspects, the techniques described herein relate to one or more tangible computer-readable storage media, further including: evaluating the node-specific base context of a first node in view of splitting instructions stored by the first node to determine whether split criteria are satisfied; and in response to determining that the split criteria are satisfied: splitting the node-specific base context of the first node into a first subset and a second subset; splitting the first node into a second node and a third node, the second node having a first node-specific base context that equals the first subset and the third node having a node-specific base context that equals the second subset.

In some aspects, the techniques described herein relate to one or more tangible computer-readable storage media, wherein the split criteria provide for splitting the first node into multiple nodes in response to determining that the node-specific base context of the first node has at least one of a length that exceeds a threshold or content referencing topics satisfy a dissimilarity threshold when compared to one another.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of example implementations.

What is claimed is:

1. A system comprising:
a plurality of nodes that each include a generative machine learning model and a node-specific base context storing at least one instruction that the generative machine learning model is instructed to follow when processing inputs;
a context-updater stored in memory and including code that is executable to:
analyze metadata generated by a chain of nodes of the plurality of nodes that processed a user request to identify an exception raised by a select node during processing of the user request;
instruct a generative machine learning model to utilize the metadata to generate a root cause descriptor that identifies a root cause of the exception, the root cause descriptor identifying information not accessible to the chain of nodes during the processing of the user request;
select, from the chain of nodes, a responsible node for supplying the information at a future time; and
based on the root cause descriptor identifying the root cause of the exception and the node-specific base context of the responsible node, update the node-specific base context of the responsible node to include the information without user input.

2. The system of claim 1, wherein the context-updater is further
executable to:
analyze a series of sequential user inputs received by the system to identify a select user input indicative of negative sentiment; and
based on the select user input indicative of negative sentiment, identify an unfulfilled request from the sequential user inputs, wherein the user request is the unfulfilled request.

3. The system of claim 1, wherein the responsible node receives a request and generates a request response automatically triggering the execution of a movement of a physical robot or a control action of a computer automation assistant.

4. The system of claim 1, wherein the context-updater selects the responsible node by operations that include:
instructing a topic similarity model to identify the responsible node within the chain of nodes, the node-specific base context of the responsible node being more similar to the root cause descriptor for the exception than the node-specific base context of each other one of the plurality of nodes.

5. The system of claim 1, wherein a node of the plurality of nodes further includes:
splitting instructions stored by the node that define split criteria for splitting the node into two separate nodes;
a node controller within the node that:
evaluates the node-specific base context of the node in view of the splitting instructions to determine whether the split criteria are satisfied; and
in response to determining that the split criteria are satisfied, split the node-specific base context of the node into a first subset and a second subset;
splits the node into a first node and a second node, the first node having a first node-specific base context that equals the first subset and the second node having a node-specific base context that equals the second subset.

6. The system of claim 5, wherein the split criteria provide for splitting the node in response to determining that the node-specific base context stores topics that satisfy a dissimilarity threshold when compared to one another, and wherein evaluating the split criteria includes:
providing portions of the node-specific base context as input to a generative machine learning model that generates embeddings of the portions and computes a relative similarity between each pair of the embeddings.

7. The system of claim 1, wherein the context-updater autonomously updates the node-specific base context of the responsible node by performing operations that include:
providing a generative machine learning model with the node-specific base context of the responsible node, the root cause descriptor for the exception, and an instruction to modify the node-specific base context to include the information identified in the root cause descriptor for the exception.

8. The system of claim 2, wherein the context-updater identifies the select user input indicative of negative sentiment by operations that include:
instructing a semantic similarity model to assess similarity of consecutively-received pairs of user inputs within the series of sequentially-received user input, wherein the select user input satisfies a similarity threshold with a previously-received input.

9. The system of claim 2, wherein the context-updater identifies the select user input indicative of negative sentiment by operations that include:
instructing a sentiment analysis model to determine a sentiment associated with each user input in the series of sequentially-received user inputs, the select user input being identified by the sentiment analysis model as conveying the negative sentiment.

10. The system of claim 1, wherein a first node of the plurality of nodes further comprises:
output management instructions that instruct the generative machine learning model of the first node to select another node from the plurality of nodes to receive outputs from the first node; and
a node controller that receives a user input and, in response, provides the generative machine learning model of the first node with a set of inputs including the user input, the node-specific base context, and the output management instructions, and wherein the first node generates an output in response to processing the user input, the output designating a next node selected from the plurality of nodes to receive and process the user input.

11. A method comprising:
analyzing metadata generated by a chain of nodes that performed processing tasks associated with a user request to identify an exception raised during processing of the user request, the chain of nodes being included within a node network and each including a generative machine learning model and a node-specific base context storing at least one instruction that the generative machine learning model is instructed to follow when processing inputs;
instructing a generative machine learning model to utilize the metadata to generate a root cause descriptor identifying a root cause of the exception, the root cause descriptor identifying information not accessible to the chain of nodes during the processing of the user request;
selecting, from the chain of nodes, a responsible node for supplying the information at a future time; and
based on the root cause descriptor for the exception and the node-specific base context of the responsible node, autonomously updating the node-specific base context of the responsible node to include the information.

12. The method of claim 11, wherein the user request is an unfulfilled request and the method further comprises:
processing a series of sequential user inputs provided by a user to the node network to identify a select user input indicative of negative sentiment, the node network including a plurality of nodes;
based on the select user input, identifying the unfulfilled request from the sequential user inputs that returned an unexpected output to the user.

13. The method of claim 11, wherein selecting the responsible node includes:
instructing a topic similarity model to identify the responsible node within the chain of nodes, wherein the node-specific base context of the responsible node is more similar to the root cause descriptor identifying the root cause of the exception than the node-specific base context of each other node in the node network.

14. The method of claim 11, wherein a node in the node network further includes:
splitting instructions stored by the node that define split criteria for splitting the node into two separate nodes, wherein the method further comprises:
evaluating the node-specific base context of the node in view of the splitting instructions to determine whether the split criteria are satisfied; and
in response to determining that the split criteria are satisfied, splitting the node-specific base context of the node into a first subset and a second subset, wherein the method further comprises splitting the node into a first node and a second node, the first node having a first node-specific base context that equals the first subset and the second node having a node-specific base context that equals the second subset.

15. The method of claim 14, wherein the split criteria provide for splitting the node into multiple nodes in response to determining that the node-specific base context stores topics that satisfy a dissimilarity threshold when compared to one another, and wherein evaluating the split criteria includes providing portions of the node-specific base context as input to a generative machine learning model that generates embeddings of the portions and computes relative similarity between each pair of the embeddings.

16. The method of claim 11, wherein autonomously updating the node-specific base context of the responsible node includes providing a generative machine learning model with the node-specific base context of the responsible node, the root cause descriptor, and an instruction to modify the node-specific base context to include the information identified in the root cause descriptor.

17. The method of claim 12, wherein processing the series of sequential user inputs to identify the select user input indicative of negative sentiment further comprises a select one of:
instructing a semantic similarity model to assess similarity of consecutively-received pairs of user inputs within the series of sequential user inputs, wherein the select user input satisfies a similarity threshold with a previously-received input; or
instructing a sentiment analysis model to determine a sentiment associated with each user input in the series of sequentially-received user inputs, the select user input being identified by the sentiment analysis model as conveying the negative sentiment.

18. One or more tangible computer-readable storage media encoding processor-executable instructions for executing a computer process, the computer process comprising:
receiving a series of sequential user inputs at a node network, the node network including a plurality of nodes that each include a generative machine learning model and a node-specific base context storing instructions that the generative machine learning model is instructed to follow when processing inputs at each node;
identifying, with a sentiment analysis model, a select user request within the series that conveys a negative sentiment;
identifying an unfulfilled request from the series of sequential user inputs, the unfulfilled request being request received immediately prior to the select user request;
identifying an exception raised during processing of the unfulfilled request within metadata generated by a chain of nodes within the node network;
instructing a first generative machine learning model to utilize the metadata and the unfulfilled request to generate a root cause descriptor identifying a root cause of the exception, the root cause descriptor identifying information not accessible to the chain of nodes during the processing of the unfulfilled request;
selecting, from the chain of nodes, a responsible node for supplying the information at a future time; and
providing a second generative machine learning model with a node-specific base context of the responsible node, the root cause descriptor, and an instruction to modify the node-specific base context to include the information identified in the root cause descriptor;
receiving an updated version of the node-specific base context as output from the responsible node; and
overwriting the node-specific base context of the responsible node with the updated version of the node-specific base context.

19. The one or more tangible computer-readable storage media of claim 18, further comprising:
evaluating the node-specific base context of a first node in view of splitting instructions stored by the first node to determine whether split criteria are satisfied; and
in response to determining that the split criteria are satisfied:
splitting the node-specific base context of the first node into a first subset and a second subset;
splitting the first node into a second node and a third node, the second node having a first node-specific base context that equals the first subset and the third node having a node-specific base context that equals the second subset.

20. The one or more tangible computer-readable storage media of claim 19, wherein the split criteria provide for splitting the first node into multiple nodes in response to determining that the node-specific base context of the first node has at least one of:
a length that exceeds a threshold; or
content referencing topics satisfy a dissimilarity threshold when compared to one another.
